(19) United States
(12) Patent Application Publication
(10) Pub. No.: US 2006/0200736 A1
(43) Pub. Date: Sep. 7, 2006

(54) Method of transmitting digital content of a content supplier to the user of an online content transmission system

(75) Inventors: Kurt Smit, Gutersloh (DE); Kan-Hung Wan, Bielefeld (DE); Matthias Runte, Buchholz (DE)

Correspondence Address: THE FIRM OF KARL F ROSS, 5676 RIVERDALE AVENUE, PO BOX 900, RIVERDALE (BRONX), NY, 10471-0900, US

(73) Assignee: arvato mobile GmbH

(21) Appl. No.: 11/249,030

(22) Filed: Oct. 12, 2005

(30) Foreign Application Priority Data
Mar. 2, 2005 (DE) 102005010131.3
Jun. 11, 2005 (WO) PCT/EP05/06274

(51) Int. Cl. G06F 17/00

(52) U.S. Cl. 715/500

(57) ABSTRACT

A method of transmitting digital contents of a content provider to the user of a content transmission system in a computer communications network in which a data set with a certain digital content desired by a download user is transmitted at least in part from a terminal of an upload user over a computer communications network to the terminal of the download user. For this purpose from terminals of different upload users fragments of the data are transmitted to the terminal of the download user.

### FIELD OF THE INVENTION

The invention relates to a method for the transmission of digital content of a content supplier to the users of an online content transmission system in a computer communications network in which a data set which contains certain content desired by a download user, is transmitted at least partly from a terminal of an upload user of the content transmission system over the computer communications network to a terminal of the download user. In addition, the invention relates to a corresponding content transmission system for carrying out such a process as well as to a terminal suitable for this process for the downloading of a digital content of a content supplier from a computer communications network.

### BACKGROUND OF THE INVENTION

In computer networks like, for example, the internet, up to now a multiplicity of different contents could be provided. Such contents include, among others, plays, pictures, music, film, software and a variety of publications of various types. Since, through newer network connection systems like for example DSL in which the bandwidth to the end user connections (that is to the terminals connected to the net, like for example PCs, laptops, etc.) has been significantly increased, up to now transmissions between private users have been very rapid and simple even for very large data sets like for example complete music titles or video films over such networks. The networks however regrettably are also widely used for illegal exchange of protected intellectual property contents. As a result the infringement of intellectual property rights has become a world-wide commercial problem.

Since on the other hand it has been extraordinarily convenient for the user to be able to receive contents like individual pieces of music or videos on a home terminal, there have been also increasing numbers of professional content suppliers whom as a rule upon receipt of certain payment, will enable a legal downloading of protected intellectual property digital content. Such content suppliers usually control content transmission systems through which the user can download the desired content respectively from a central server of the content supplier. One such centralized system architecture enables a very simple control over the transported contents. However, for the individual user upon downloading (hereinafter also referred to in the usual notation as a “download”) of contents from a central server, the band width available becomes ever smaller as more users seek in parallel downloads from this server. For the content supplier or the operator of such a content transmission system (hereinafter referred to also as the “download platform”) it is then only a question of time before it is required to add hardware, for example by the parallel connection of additional servers, to again raise the bandwidth or, in the alternative to anger the user because of the reduced download bandwidth to the point that the user will no longer utilize the service. As a result, the operator of such a download platform must consider investments in new hardware which only means that the charges must be increased to cover the relatively high hardware costs. The prices for legal downloads of protected intellectual property content then become more expensive and additional users might then be motivated to utilize illegal information exchange platforms. Indeed the users of such illegal information exchange platforms may be subject to penalties but this however also is problematical since the penalties are limited by national boundaries. The probability of successful prosecution is thus very minor. Since such download platforms with illegal protected intellectual property content mostly operate without cost the establishment of download platforms with exclusively legal content is complicated by the need to cover the license fees which must be provided to rights holders and must be included in the price for the utilization of the contents.

A possible solution to this dilemma has been described in US 2004/0030651 A1. In the method mentioned there, by appropriate means, the user of the system can seek to download the desired digital content from another user of the system. In this case, however, the user who wishes to download the contents must pay a corresponding fee and a portion of this fee is delivered to the user who has transmitted the contents. For this purpose the digital content is initially prepared by a service provider, for example in a special coded form. Then the content can in the usual way be downloaded from a central server by the first user. When a further user requires the content, however, he must download this content from the terminal of the first user. In connection therewith the downloading user must obtain from the service provider its permission to use the digital content. Against the payment of a fee, a use authorization for the digital content is obtained from the service provider. Following receipt of this authorization by the second user, he can use the downloaded digital content. In addition apart from a payment of the license fee to the rights holder, a payment to the first user is effected who has passed along the digital content. A third user who requires this digital content can download it either from the second or alternatively from the first user. It is thus possible that corresponding payments will be made to each user in the chain of transmission.

This transmission method or this content transmission system has the advantage that the transmissions are effected through a decentralized system structure over a so-called “Peer-to-Peer (P2P)-Network” by which the content is passed from one user to another user. The content is provided in the network as a rule in a number of copies so that the loading or the download of the content over the network is distributed. Such a peer-to-peer system structure is significantly less expensive than a classical sender download platform since it is not necessary to expand the infrastructure with new servers with increasing numbers of users but the number of users can increase simultaneously with the number of potential uploaders (that is the number of users from whom the content can be transmitted to other users). With increasing user numbers, therefore, there is no automatic increase in the cost of the infrastructure. As a result the cost for legal downloading of protected intellectual property digital content can be significantly reduced and thus the attractiveness of the use of illegal transfer platforms will drop in proportion to that of legal platforms. A further advantage is that the users who are prepared to transmit digital contents to others receive a compensation for it. It is to be expected that the readiness of a user to illegally transmit protected intellectual property contents to another will diminish when he, through the use of a legal peer-to-peer platform, will receive compensation. Conversely, also the downloader who has received such legal contents within the peer-to-peer platform is motivated to pass that content along in a legal manner to another user and therefore receive compensation. In spite of the fact that there is a fee for the download, therefore, even the download user finds it more satisfactory to obtain protected digital content from a content supplier in a legal manner since he, upon sending along the content to another, can recover the cost and possibly over a long term even profit therefrom. For the rights holder itself, such a system has the advantage that a new distribution channel is provided which significantly reduces the attractiveness of illegal exchange.

The disadvantage of the aforedescribed method however is that in the transmission of the data sets in a peer-to-peer network the transmission rate relative to that of a download from a server is relatively small. In so-called asymmetrical networks like for example a DSL network, the end user of the network usually operates with a relatively high download band width but however with a substantially lesser upload point band for the uploading of the data from the terminal to the net. For this example at the present time a DSL connection can have a download rate of 780 bit/s whereas the upload rate will only amount to 128 bit/s. In future satellite supported networks, the discrepancy between upload and download rates is expected to be still greater, for example 15M bit/s for the download rate and only 64 bit/s or 128 bit/s upload. Under these circumstances in most situations, for example with browsers in the internet, significantly larger amounts of data will be downloaded by users than will be uploaded to the net. In a peer-to-peer data transmission, the upload bandwidth of the upload terminal is the limiting factor on the digital content which can be transmitted. As a consequence it is a given that in such a network a download of a digital content will take significantly longer on the average than in a central network in which the user will download the digital content respectively from a server especially provided for this purpose and with a sufficiently large upload bandwidth at its terminal.

### OBJECT OF THE INVENTION

It is the object of the present invention to so develop a method of the aforedescribed type further that the download can be accelerated and especially the aforementioned drawbacks with respect to a central content transmission system can be obviated.

### SUMMARY OF THE INVENTION

According to the invention, fragments of the data sets of terminals of different upload users are transmitted to the terminal of the download user. That means that with the method according to the invention for the downloading of a digital content of a content supplier from a computer communications network to a terminal of a download user, a content transmission system in accordance with the invention will provide that the terminal of the download user receive fragments of the data set from terminals of different upload users. By the term “download user” is here to be understood a user who desires to download a data set with a certain content to his terminal, while the “upload user” is a user of the system at whose terminal, conditions for this download are available, that is for this transmission, data set parts have been uploaded from he peer-to-peer network for this predetermined content. It is clear that this designation applies to a particular data set transfer and in other situations the roles may be reversed, that is a download user can become an upload user and vice versa.

Such a method according to the invention reduces the download time in asymmetric networks like for example DSL very significantly since multiple upload terminals with a limited upload bandwidth can service one download terminal with a higher download bandwidth. The fragments command from various terminals of the upload user can supply the desired data in parallel to the receiving download user. The term “parallel” is used here in he sense of the transmission protocol. Indeed at the lowest network level which is considered, the individual transmission packet are technically transmitted serially. However, the individual packets are supplied such that the download terminal has no influence on eh sequence of the packets as received at the download terminal and thus the download of the width can be optimally used and the fragments transmitted as rapidly as possible. The desired data must be reconstructed following receipt by the download user only after the fragments have been obtained from the various terminals. This does not however pose a problem since even with classical transmissions of data sets from only a single other terminal connected to the network, the transmission is effected in a packetwise manner and a corresponding reconstruction of the data set is required by the receiver. Suitable methods for this purpose are available to the skilled worker in the art.

The content transmission system according to the invention for the transmission of digital content from a content supplier to a terminal of a download user of the content transmission system in a computer network, comprises a transfer initialization device which after receiving a request from a download user enables for certain content at the terminal of the download user to be received in the form of fragments of the data set with the desired content from different selected candidate upload terminals. By the term “candidate upload terminal” we refer to terminals at which part of a predetermined data set with desired content for the transmission to the download terminal is prepared at the terminal of the download user.

On behalf of the download user there must be a downloading of the digital content available from a content supplier to a computer communications network which, apart from a network interface for receipt of fragments of the data from other terminals connected to the computer communications network, has a suitable transaction control unit which is so configured that the terminal receives fragments of the data from terminals of different upload users.

Such terminals can form any optional final unit connectable to a computer communication network, for example a PC, a laptop, a personal digital assistant (PDA), a mobile radio unit with a suitable layout or a device which is provided specially to receive a process digital contact like for example a Set-Top-Box for use with a television set, a MP3 player or the like.

Usually such terminals are programmable devices. In that case, for example, the transaction control unit and the other components necessary for carrying out the invention or for carrying out a particular device of the invention can be implemented in the form of software on the terminal. This has the advantage that by appropriate software installation already existing terminals can be equipped to carry out functions in accordance with the invention.

The dependent claims contain especially advantageous features and configurations of the invention, whereby the content transmission system of the invention and the terminal of the invention can be equipped or configured to carry out the method of the invention or whereby the method of the invention can conversely be modified to suit the content transmission system for the terminal.

In order to supply the user with the desired content reliably and to rapidly as possible, preferably at least a part of the fragments of the data set are transmitted from a special base-storage terminal of the content transmission system provided specially for that purpose, to the terminal of the download user, when no terminals of upload users are available or too few terminals of upload users are available to provide the missing parts of the data set for transmission. For this purpose, the transaction control unit of the terminals of the download users, hereinafter also referred to as download terminals, need only be configured so that the terminal can receive at least part of the fragments of the data set from such a base storage terminal. This base storage terminal can for example be a server of the content provider and/or of the operator of the content transmission system. It will be self-understood that within the content transmission system also a number of such base storage terminals can be available.

One such base storage terminal is as a rule required at least when none of the users of the data set has received the corresponding content, that is for the first time downloading of the content in the peer-to-peer network. As to this, according to a preferred embodiment, in certain situations at least one base terminal is used in parallel to the terminals of the upload user in order to maintain the download speed at a certain level.

For example, the second user which is to be supplied with a certain content can receive the data set from the corresponding content in part from the first user and to a further part the central base storage terminal. If a third user is to receive the same content, he obtains it in part from the terminals of the first and second users and a parallel part from a base storage terminal. This approach is carried out until a maximum number of terminals of upload users is reached. The central base storage terminal then passes into the background and is used to a lesser extent and is thereby over time is loaded to a lesser extent.

The organization as to which fragments of the data are to be downloaded from which upload terminals can be determined by the transaction control unit of the terminal of the download user. The maximum number of upload terminals can then be so set that the total upload bandwidth which is achieved by the various upload terminals, corresponds approximately to the download bandwidth which is available at the terminal of the download user. This maximum number of upload terminals need not be fixed but can vary depending upon the individual upload terminals which are available and the upload bandwidths available at them. The distribution can correspondingly also be selected to determine how many fractions of the data set can be downloaded from which of the upload terminals. By the term “upload terminal” we understand not only the terminals of upload users which are generally available but also a central base storage terminal upon which the data set is available for download.

Preferably the terminal of the download user sends request signals to possible upload terminals on which at least specific parts of the data sets are in readiness for an upload, the request signals requesting the predetermined fragments of the desired data set. The respective requested segments are then transferred from the respective upload terminal to the download terminal.

In an especially preferred embodiment, the terminal of the download user sends to an upload terminal a request signal block which requests simultaneously a plurality of fragments of the desired data set. This accelerates the transfer process significantly since thereby the overhead with respect to control data in proportion to the use data to be transported is greatly reduced. This mode of operation is also sensible in other networks in which a data set is not transmitted in parallel from a plurality of uploaders to a downloader but rather in a manner such that the data set for a downloader is transferred only from one upload terminal. This method can also contribute as its own inventive feature to the solution of the above mentioned object in accelerating a download.

Since the terminal of the download user can be informed as to which upload terminal request signals can be sent primarily, in a preferred embodiment, from the terminal of the download user a request can be made to a central indexing unit of the content transmission system for a certain content. From this central indexing unit, a group of candidate upload terminals can be identified in which at least a part of the data set, usually the entire data set, is in readiness for an upload. From the central indexing unit, address information is forwarded to the terminal of the download user, including for example the internet urls or similar network addresses of the candidate upload terminals that have been identified for the download terminal. To the extent that the download terminal has received this information, it can send at least to a part of the candidate upload terminals the request signals for requesting certain fragments of the data set.

In an especially advantageous embodiment, the transfer initialization unit of the content transmission system can have a corresponding indexing unit. The central indexing unit comprises in this case a suitable storage or memory unit which contains the information as to which terminal of different users of the content transmission system or which based storage terminals have the content in readiness. In addition, the indexing device can have a selector unit which, following receipt of a request from a user for a certain content from these terminals, can identify the group of candidate upload terminals in accordance with predetermined criteria.

Since the central indexing unit has available the requisite information as to availability, the indexing unit of a terminal of a user of the contact transmission system, when a data set is on this terminal in readiness for an upload to another user of the content transmission system, will receive an offer signal containing information as to the availability of the data set. This means that possible upload users communicate with the indexing unit. When a certain user regularly and/or continuously on his terminal maintains data set available for download to other users, it is sufficient when this offer signal contains only the information as to whether the offer of the respective user has changed to any extent since the last transmission of an offer signal.

The choice of the upload terminal to which a request signal for a fragment is to be sent from a download terminal is effected preferably in dependence upon the priority set at the individual upload terminals. Preferably with the indexing units themselves the candidate upload terminals are selected as a function of priority values and are prioritized, that is in a matching sequence or line up, for transmission to the download terminal so that the download terminal will issue the request signals to the candidate upload terminals in the corresponding sequence as determined by the indexing device. However, in an alternative, the priority value can be delivered with the address information and then potential upload terminals can receive their requests corresponding to the priority values in series. The priority values can be created for the terminals of the various upload users upon initial registration with the content provider or the system operator or by a later application when a possible uploader is registered. For example, the priorities can be selected as a function of the quality of the data connections, especially taking into consideration the upload bandwidth which may be available. However other optional criteria can be considered in determining the priorities. Furthermore, the priority of a certain upload terminal can be varied from time to time, for example, to be certain that potential upload terminals are loaded as uniformly as possible to the extent that this may effect the quality of an upload at the upload user and so that all potential upload users will have a chance to receive compensation correspondingly. Basically however, any other optional waiting function can be conceivable to determine the upload user, for example, whether the upload user is an original customer, based upon predetermined criteria of the content supplier.

Advantageously, a data set, which can have a certain or predetermined digital content, for example a complete video film, a music title or similar content, can be provided with a singular or characterizing code like, for example, a singular or specific name, a code number or the like which is individual to that data set. Especially preferably a code is used which simultaneously also serves for securing and authenticating the data set, that is which is independent of the content of the data set.

For this purpose the use of a hash value of the relevant data set or the like is proffered. With the use of such coding for requesting a data set or parts of a data set, the desired data set can be singularly identified whereby it can be easily ascertained whether the desired and already authenticated data set is provided. Especially, the download user can detect whether the content of a data set is complete, unaltered and unfalsified upon its delivery. It is also possible to determine whether any change in the data set was done intentionally by an intentional manipulation or unintentionally, for example as a result of a transmission error.

In an especially preferred variant or embodiment of the invention, each data set is subdivided into a number of defined segments and each of those segments has a respective singular code assigned thereto. Preferably a request signal of the download terminal to an upload terminal contains the singular code of the segments of the data to which a respective requested fragment belong. Advantageously, the request for the segment is provided in the requisite sequence required for the subsequent use so that the earliest possible use of the data set can be achieved.

The subdivision into individual segments has the advantage that one need not wait for a complete download in order to test the transmitted data, but it is sufficient when the download terminal has received a complete segment to effect such testing or evaluation. Thus the respective segment can be tested with the aid of the singular code and a determination made whether the segment is complete and has been transmitted truly or if other steps are required, for example, a new request, for a specific segment or fragment.

In a preferred variant of the method, the download terminal sends, when a first segment of a specified fragment is incomplete or has not been received, a request signal to another candidate upload terminal for a fragment which corresponds precisely to the defective or omitted part of the fragment transmitted from the upload terminal. That means that, by contrast with conventional methods, the incomplete fragment need not be requested completely from another upload terminal, but it is sufficient for the remainder of the fragment which has not been supplied in order to be requested anew. This significantly accelerates the transmission process, especially in peer-to-peer networks in which it can happen that an upload user, whose terminal is being employed for an upload can have that terminal cut off or interrupted on various grounds and thus cannot deliver a transmission of a fragment which has already begun, to its end. In such a case it is advantageous even in other networks in which a data set is not transmitted in parallel from a plurality of uploaders to a downloader, for the downloader to obtain the data set from more than one upload terminal. Even in such cases it is advantageous to be able to use the correctly transmitted part of the data set and to have the download terminal request only the unsupplied part from the same or another uploader. This method also can be an independent invention towards the solution of the above described object in accelerating a download.

Preferably a request signal of the terminal of the download user to an upload terminal contains not only the singular code of the data set and/or the segments of the data set which belong to a requested fragment, but also an offset value which represents the position of the fragment within the data set or of the segments of the data set, as well as a value representing the length of the fragment. With this method or structuring the request signal, the requesting terminal can specify the fragments with considerable precision so that there are no problems with request or fragment remainders as might be the case when an initially requested fragment is not completely supplied.

In order to ensure that the data will not be used in an unauthorized manner, the data sets are each keyed within the content transmission system and transmitted to the user or further transmitted. In order to enable the data set then to be used, for example on the respective downloading terminal, i.e. to be seen or to be heard, and the data set to be opened, for the data set to be copied to a data memory or store, or to especially burn the data set to a CD, the user requires a matching “key” for this data. This can, by suitable choice of the keying and the key, for example, be provided as a function of the payment of a fee by the various users for the different rights, for example, whether a data set is to be used at a terminal in an unlimited manner (unlimited number of plays) or in a limited number of plays or burning operations, and how often transfers to other devices, like MP3 players are to be permitted. The key can also have a limited life, i.e. a fixed time duration. Suitable keying processes are known in the art. For example, the usual DRM process (DRM=Digital Rights Management) protocol may be used as it is supplied, among others by Microsoft®. A programing of such a DRM system can for example be carried out based upon the extensible Rights Markup Language (XRML).

Advantageously, the download user is supplied with a corresponding key for unlocking the data set already prior to the transmission of fragments of the data. When the download terminal is provided with the key already prior to receipt of fragments of the data set it is possible, especially in the case, as described above, of segment wise testing of the data to unlock the received parts of the data even before the end of a complete data set download. This has the advantage that the digital context can already be used during the download. For example, a video film, which because of the large amount of data as a rule is generally delayed for a lengthy period, can be viewed by the download user practically immediately.

In a preferred variant of the method, a user, in order to utilize the content transmission system, must initially be authenticated in an authentication process with respect to an authentication unit. Following such authentication, the user is sent an authentication code. With this authentication code the user can, in the further course of the process, be authenticated with respect to other functional units of the content transmission system. This method has the advantage that a complete organizational separation of the content provider who is exposed to the public and approached by the user from the actual operator of the content transmission system, here and after referred to also briefly as the “system operator” is possible, whereby the user will appear to be authenticated by the authentication unit apparently under control of the content supplier and obtain the authentication code from it. This authentication code can be used with respect to all functional units of the system operator. The system operator thus need not itself carry out any exact authentication of the respective user and it is especially not required for the system operator to maintain a password, username or the like for each respective user or even to know the passwords or usernames which may be maintained by the content provided. Especially, this method enables firms which normally have various branches to serve as a vendor or operator as a service provider for the supply of beverages, sweets, toys, furniture or the like to function as a supplier without great additional expense of videos, music, software or the like as a content provider over the internet. As a consequence, the firm need not itself maintain all of the requisite infrastructure and service it but it can use the service of an operator of a content transmission system according to the invention.

Preferably such an authentication code can be used in combination with conventional cryptographic methods like for example are used in the clearing of data transmission for other users or terminals to provide a singular identification of the respective communication partner.

Such an authentication code can have time limits or limits with respect to a particular location of the user so that the user for example each time it newly accesses the system can be given a new authentication code if desired. In addition, such an authentication code can be provided on a one time basis upon the initial registration of the user.

In an especially preferred method, a further separation is provided in that at the download user (as a rule directly on the download terminal) after a selection is made, that is after the purchase of digital content available from a content provider, a data receipt authorization code and a key receipt authorization code are transmitted. From the download user, the data receipt transmission code can be sent to the respective upload terminal for receipt of the fragments of the desired data. The key receipt authorization code is, by contrast, forwarded to the licensing unit to obtain the key. This has the advantage that the licensing unit can be independent from the connection between the end user and the content provider and/or the system operator. Indeed, it is basically possible that for example the content provider and/or the operator of the content transmission system will also operate the licensing unit and be involved itself in the distribution of licenses for the content. On the other hand, a separation of these functions allows for example the licensing unit to be operated by the owner of the original rights or the possessor of the licensing rights to the content and the content provider and the system operator, thereby eliminating the need for accounting with the right owner and the need for secure transmission of data with the license provider. Especially this permits both the content provider and the system operator to supply content from a variety of rights owners and enables each rights owners to utilize different licensing services and licensing units in the method, depending upon which rights owner has originated or possesses the licensing right for the respective desired content.

To the extent that the content provider and the system operator are separate organizational units, a number of different content providers can utilize the content transmission system of a single system operator. For this purpose, preferably each data set which derives from a certain content provider of available digital content and/or each segment of such a data set can have a singular code within the content transmission system and which not only depends upon the content of the data set for the segment but also upon the identity of the respective content provider. This means that simultaneously data sets with the same content within the content transmission system but deriving from different content providers will have different singular codes. Within the content available from a certain content provider, the coding of the data set is thus singular and individual to that content provider. Upon a change in the data, there is also a change in the code so that the data can no longer be authenticated as previously with the aid of the code. This is then for example possible when the code is a hash value not only upon the data set but also additionally over a singular code of a content provider. This preferred method has the advantage that only concern by the content provider that the user will obtain data sets from that content provider through the Peer-to-Peer network will apply. In this manner the content provider can ensure that, so far as one of his users requires a content, this content will also be transmitted from another of his users and when a corresponding compensation is paid the compensation will be paid to his own users.

To establish a compensation for the upload user, the content transmission system preferably has a transaction control unit or device which, after a transmission of fragments of the data from the upload terminal to the terminal of the download user, receives relevant data from the upload terminal and/or from the terminal of the download user. Based upon this data, a compensation of the upload user for the supply or availability setting of the respective upload terminal for transmitting the data to the terminal of the download user can be determined. For this purpose, the compensation can be “use dependent”, for example based upon the amount of the transmitted data. Additionally, this data can also be used for a simple control or monitoring of the transaction, that is to determine whether for example the download user has also received the identical amount of data which has been sent by the upload terminal.

At a first level it is provided that within the content transmission system, data sets are transmitted which are initially in readiness on a central based storage terminal by the content provider and/or the system operator. This content is correspondingly tested in advance and provided with a corresponding code, for example verified by a hash value and thereby authorized for a transmission within the system. Basically however it is also possible that a user may have a legal version of content obtained by himself or obtained in cooperation with others or obtained in some other manner and is willing to make that content available within the content transmission system. A data set with relevant digital content can then initially be tested by the content provider and/or the network operator and upon a positive test, this data set can also be provided with a code. It is naturally not required, when to carry out such a test when the data set itself is obtained by the user within the content transmission system. Such a data set then will already have a singular code or code which is individual to that data set for use within the content transmission system. Basically it is also possible to provide data carriers with certain content which is commercially available and which already has been authorized for transmission within a specific content transmission system and as such already has an appropriate code. This has the advantage that a user can directly upon purchase of such a tested legal version of the content not only use it for his own purpose but also make it available on a terminal for transmission to other users within the respective content transmission system and to the extent that his terminal is used for uploads to other users, can receive corresponding compensation with which he can refinance or recoup the cost of the content.

So that a particular user can initially be informed as to what content a particular content provider has available, the content transmission system has a source or supply monitoring unit which is either maintained by the system provider of the content supplier or by the content supplier itself. Such a content supply shop can be searched by a user in the usual manner, for example with an appropriate browser over the internet. The user can then indicate which of the available content is to be selected and obtain method data including for example additional information with respect to the content or a trailer or the like or some other segment of the content for a test. As is common in internet shops, the user then selects the content and preferably can have a virtual basket for the product in which all selected content is contained to the end of a sitting and the handling of the various payment modalities, before downloading.

In an especially preferred variant, information as to particular users and their terminals in readiness for an upload to another user of the content transmission system of content can be derived from a availability information unit which is found on the terminal of the respective user and from which a terminal of another user can call up that information. That means that the respective user can himself on his terminal maintain a kind of “user shop” which other users can visit in the system exactly as a content supply shop is visited using a browser. The respective user can in its own shop for example provide its own evaluation of the content and/or recommendations. He can thereby also activate other users to download particular content. To the extent that a user decides to download such content, however, preferably independently of whether the download user is utilizing the shop of another user or the shop of the content provider for the download, a download in the sense of the invention will always be carried out with a plurality of terminals to another user of the system. To the extent that the download user also visits the shop of another user for the download, the respective user can have a provision which may be available for respective users for an adjustment when they do not participate in uploads.

This procedure strengthens the bond between the user and a particular content provider and activates the user to be an active participant in the content transmission system.

### BRIEF DESCRIPTION OF THE DRAWING

The invention is described in greater detail below in connection with the accompanying figures based upon samples or embodiments. In the drawing:

FIG. 1 is a schematic illustration of the course of a transmission of a content to a first user, a second user and a third user in accordance with the invention;

FIG. 2 is a schematic illustration of a data set subdivided into a plurality of segments;

FIG. 3 is a block diagram illustrating the principles of a structure of an embodiment of the content transmission system according to the invention;

FIG. 4 is a block diagram illustrating the principles of an embodiment of a terminal usable within the method;

FIG. 5 is a detailed schematic illustration of the course of a download in accordance with a further embodiment of the invention;

FIG. 6 is a schematic illustration of a possible application of a terminal secured with a fire wall; and

FIG. 7 is a schematic illustration of the course of a download from a fire wall secured terminal.

### SPECIFIC DESCRIPTION

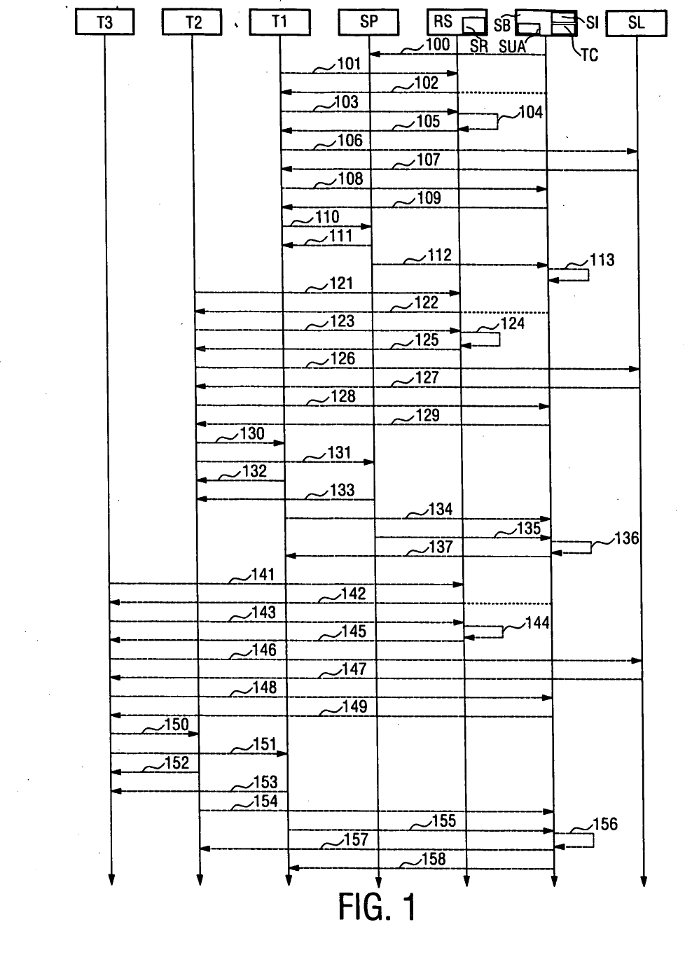

In FIG. 1, in highly simplified form, a possible course of the method according to the invention for download to the terminals T1, T2, T3 of the first three users of a content transmission system has been shown which enables the downloading of a data set with a certain content.

It is assumed initially that the relevant data set can be found on a base storage terminal SP, hereinafter also in short a “seed peer” SP for a first time download by a user. For this purpose, the data set with the corresponding content is prepared by a system operator SB, for example, tested and coded and secured by a singular code, for example, a hash value and provided on the seed peer SP.

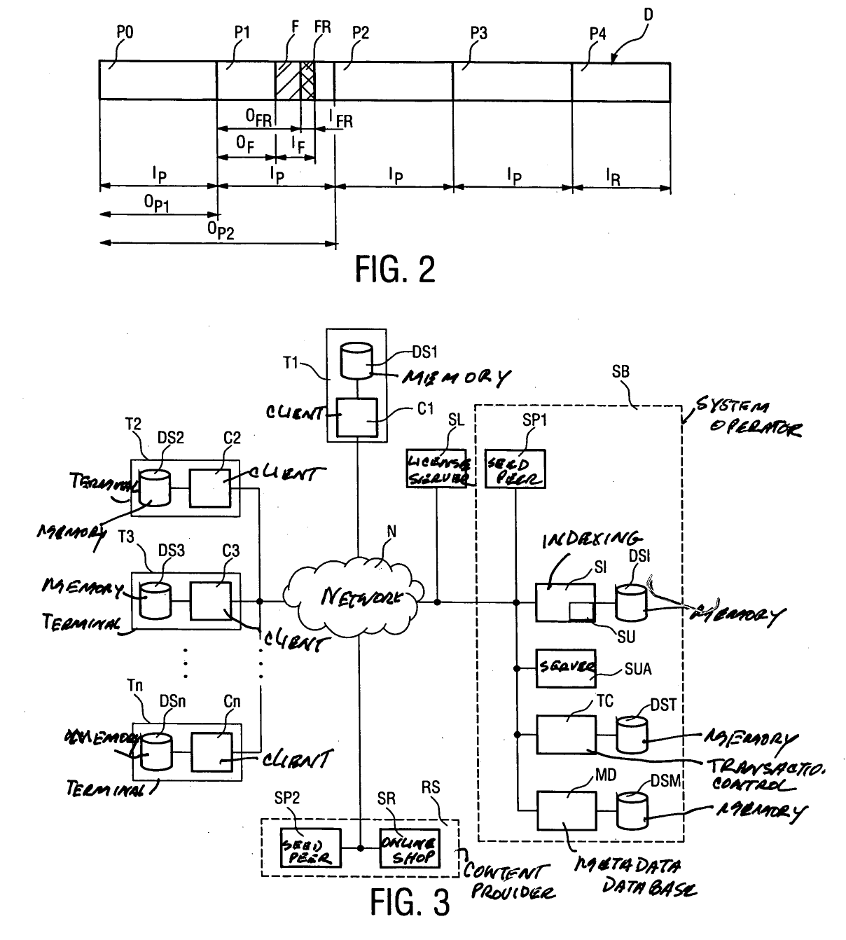

In the preparation step, the data set D is also subdivided into a certain number of segments P0, P1, P2, P3, P4 and these individual segments, P0, P1, P2, P3, P4 are assigned particular code values, for example, hash values. The segments P0, P1, P2, P3, P4 of a data set D are each characterized by an index. The first segment P0 carries the index 0. Each of these segments P0, P1, P2, P3, P4 has an offset 0_{P1}, O_{P2} which marks the beginning of the segment of the data set D and a fixed length I_{P}, I_{R}. The structure of such a subdivided data set D is schematically shown in FIG. 2 whereby however of the offsets, so as to enable better review, only the offsets 0_{P1}, 0_{P2} of the second segment P1 and the third segment P2 are indicated. The there shown data set D is divided into a total of five segments P0, P1, P2, P3, P4, whereby all segments up to the last segment of P4 have the same lengths I_{P}. Only the last segment P4 has a length I_{R} which corresponds to the residual length of the data set D. The length of such segment can in principle be freely selected and depends as well from the length of the entire data set. Thus, in a first embodiment, it can be provided that segments of a music title will have lengths I_{P} of 1 mb and segments of a video film a length I_{P} of 8 mb.

The coding of the data set D or of the individual segments P0, P1, P2, P3, P4 is respectively so singularly created that the code will no longer match when the content of the segments P0, P1, P2, P3, P4 or the data set D are altered. In this manner, using the coding, it is possible to test whether a data set D or a segment P0, P1, P2, P3, P4 has been manipulated or modified in some other way. The coding is, in addition, dependent upon the content provider RS so that one and the same data set or one segment of such a data set which has been supplied by two different content suppliers will not have the same coding.

The data sets or parts of the data sets can be downloaded at any time by the users from the seed peer SP by presenting a singular or distinctive coding for a segment P0, P1, P2, P3, P4 of the desired data set.

As a consequence, each download of these segments P0, P1, P2, P3, P4 in the case of a later data supply from a download terminal, is effected independently of whether the supply is from a seed peer or a terminal of an upload user, and is divided into fragments F. One fragment F is therefore a unit which, as a bundle, is transmitted precisely from an upload terminal intact to a download terminal through the network. The fragments F each have an index, an offset value O_{F} and a length I_{F}. The role of the index, however, unlike the segments P0, P1, P2, P3, P4, need not absolutely represent the sequence position of the fragment F within the segments P0, P1, P2, P3, P4,. The offset value O_{F} gives the relative displacement within the segment, that is the spacing of the starting point of the fragment F from the starting point of the segment. The first fragment F as a rule carries the index O. The offset O_{F} and the length I_{F} of the called up fragment can be freely selected by the downloader directly prior to the download. The length of a fragment can, for example, be of the order of 256 KB. The size and number of the fragment need not be fixed at the beginning of data set transfer. An upload terminal which receives the request transmits precisely the data which the download terminal requests.

This has the advantage that when, during the transmission of a fragment F, the connection is interrupted and only a part of the fragment F is transmitted, from the terminal T2 only an interrogatory to another terminal must be transmitted to obtain the remaining part of the fragment, i.e. fragment remainder F_{R}. This has been indicated in FIG. 2. For example, when the fragment F has already been transmitted up to a fragment remainder F_{R}, only a new fragment must be ordered up which has an offset value O_{FR} and a length I_{FR} of the fragment remainder. It is thus not required to download the complete fragment again from another terminal which would be very time consuming.

The preparation and readiness of the content on the seed peer SP is shown in FIG. 1 in step 100. The set up of the data set D by the system operator SB on the seed peer SP is effected as a rule in accordance with the conditions determined by or the requirements of the content provider RS.

At any later point in time, a first user can transmit a request of a first terminal T1 to the content provider RS or to the server assigned to the content provider RS with which the content provider RS operates an internet online shop SR (step 101). He then obtains, after he has been appropriately authenticated, in step 102 an authentication code, referred to below as a “ticket” which is effective for the entire sitting. To produce these tickets, a part of a server SUA assigned to the content provider RS and of the system operator SB, which serves especially for authentication purposes, is activated. One possible approach upon receipt of the application request is detailed subsequently.

In step 103, the first user, by means of his terminal T1, for example, with the aid of the usual browser selects from the internet shop of the content supplier a content and purchases it.

When the first user for a first content has selected and “purchased” the content, in step 104, an accounting is effected with the content provider RS. Than in step 105 the singular code of the data set D and the associated segments P0, P1, P2, P3, P4 as well as a data set receipt authorization code, hereinafter the “download-ID” are assigned and a key reception authorization code or “voucher” are forwarded to the terminal T1 of the first user.

The voucher is time limited, that is the user must use the voucher to obtain a key for the data set D within a predetermined time. For this purpose, the first user transmits from his terminal T1 based upon the content of the voucher, a key request to a license server SL (step 106) and receives from the license server SL the key at his terminal T1 (step 107) in a following step 108, the terminal T1 transmits the ticket and the code of the desired data set in the form of a sauce request to a central indexing unit SI which here belongs to the system operator SB and, for example, is installed on a server of the system operator SB which has also various other functions. From this server, in step 109 address information is transmitted to the terminal T1 which identifies the candidate upload terminals upon which the data set with the desired content is available. The indexing unit SI in this case searches out the candidate terminal uploads based upon the priorities assigned to the individual terminals and in accordance with a predetermined setting function and transmits the address information in the sequence in which the terminal T1 is to request from the individual candidate upload terminals the fragment F of the desired data set D therefrom.

In the example illustrated in the upper part of FIG. 1, the first download of certain content is shown. This data set has hitherto only been made available on the seed peer SP. The terminal T1 of the first user thus contains only the address of the seed peer SP. From the terminal T1 the user in step 110 sends a request signal to the seed peer SP, whereupon in step 111, the desired fragments, in this case one after another account for the complete data set, are transmitted to the terminal T1.

From the seed peer SP, after this transmission, in step 112, accomplishment data is transmitted to the system operator SB which has in step 113 monitored is download. For example, the terminal T1 can also transmit accomplishment data to the system operator SB for comparison with that of the seed peer SP to indicate that the data has been transmitted and received by the download terminal T1. This step is not, however, illustrated in FIG. 1.

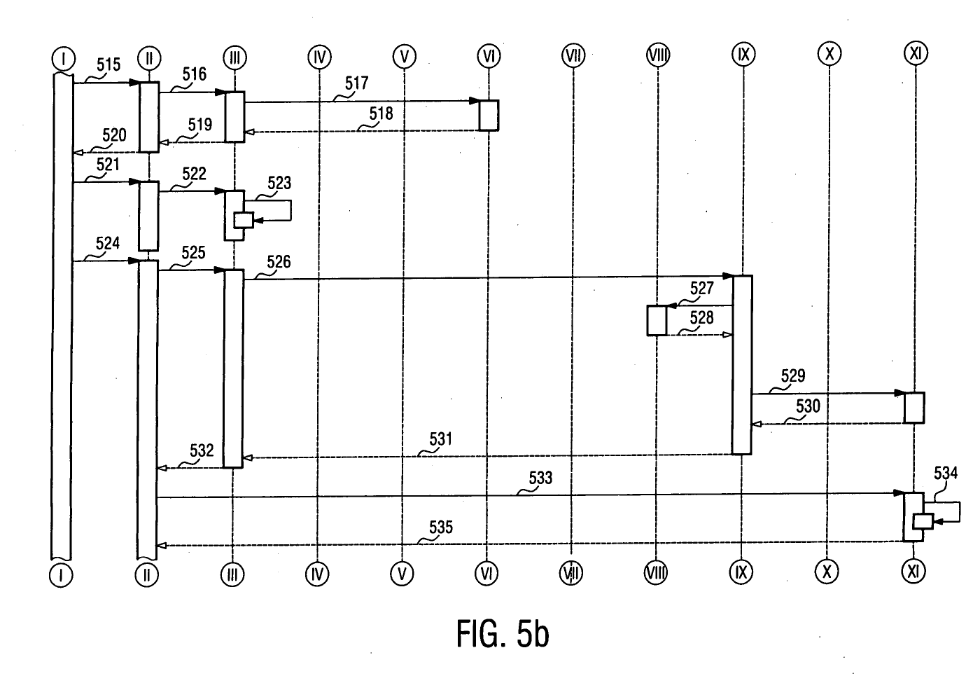

In the indexing unit SI it is known that the data set is present not only with the content of interest on the base storage terminal SP but also upon the terminal T1 of the first user. In the further steps it will be assumed that the terminal. T1 of the first user also is able to supply the data set to other users or maintains that data set available for use by other users. It will be understood that a special registration maybe provided for the users who wish to make the data set available since not every user will be prepared to utilize his terminal for uploads and also that not every terminal will always be connected to the net. A possible method for such special “uploader registration” will be described in greater detail in connection with FIG. 5.

In the example according to FIG. 1, it is further assumed that a second user is desirous in step 121 with his terminal T2 of downloading the data set and has communicated with the content provider RS and in step 122 has obtained a ticket, has sought the content in step 123, thereby selecting the content like the first user has before him. After the second user has decided on this content, an accounting is made by the content provider in step 124. In the following step 125, there is transmitted the code of the data and the segments, the “download ID” and the “voucher” to the terminal T2 of the second user. In step 126, the terminal T2 sends a key request based upon the data of the voucher to the license server SL and thereafter in step 127, the license server transmits the key back to the terminal T2. Based upon the information on the tickets of the second user in step 128, there is a source request from the terminal T2 to the central indexing unit SI of the system operator SB which in step 129 supplies the address information as to which candidate upload terminals the data is in readiness for the expected content download, to the terminal T2. In the illustrated example, this is the address of the terminal T1 of the first user and the address of the seed peer SP. In steps 130 and 131, therefore, the terminal T2 forwards request signals from the second user to the two terminals T2 and SP in question. This includes a transmission of the download ID based upon which the available uploads from the terminals T2 and SP are checked for the authentication of the download terminal T2. The upload terminals T1, SB in steps 132 and 133 forward the requested fragments of the data set to the terminal T2 of the second user. At the end of the download, the terminal T1 of the first user and the terminal of the seed peer SP in steps 134, 135 send respective acknowledgment data to the system operator SB indicating completion of the delivery of the fragments to the system operator controlling the transaction (step 136). The control of the transaction also indicates how much data from the first user is supplied by his terminal T1 to the terminal T2 of the second user and thus also the compensation for the first user because of the availability status of his terminal T1 for the download to the second user.

In step 137, correspondingly, a compensation message is sent to the terminal T1 of the first user. This compensation can be a credit to the first user so that he can obtain for example at a later date, other downloads covered by the compensation and against which the cost of such downloads can be charged. It is, however, also possible that the system operator SB or the content provider RS can maintain accounts for the user and provide the user with a payment in some other way, for example, a payment when a particular minimum accrual is reached. The transmission of such a credit message is optional. It has, however, the advantage that an upload user can be provided with the information or be enabled to inquire to what extent his upload availability has contributed to an economic benefit. It is, therefore, an additional motivation to have the user make available his terminal for uploading.

Assume that both the first user and the second user have their terminals T1 and T2 available for uploads with respect to a third user who wishes to download the same content. In this case a total of three terminals are available, namely, the terminal T1 of the first user, terminal T2 of the second user and the terminal of the seed peer SP.

This scenario is shown in the lower third of FIG. 1. The third user as well must first, in step 141 with his terminal T3, communicate with the content supplier RS and obtain in step 142 a ticket. In step 143, he can then in the online shop SR of the content supplier RS select the conduct he desires. As soon as he has determined the content sought, in step 144, there is an accounting. In step 145 the codes of the data set and the segments, a download ID and a voucher are sent to the terminal T3 of the third user. In step 146, from terminal T3, via the transmission of the voucher, a key request is sent to the license server SL, whereupon in step 147, the key is sent back. Apart from this, the terminal T3 sends, in step 148 based upon the ticket, to the system operator SB or the central indexing unit SI an inquiry as to possible upload terminals and receives in step 149 the addresses of the terminals T2 of the second user and T1 of the first user.

In the case shown in FIG. 1, it is assumed that based upon the available download and upload rates it is sufficient, when the third user with his terminal T3 seeks to download the data set, that two upload terminals T1, T2 of other users will be sufficient. In the case that this is not so, additional upload terminals can be used for the download of the data set, for example, 10 or more for downloading a data set to one download set terminal. In addition, with the transmission of the address information 149, the address of a seed peer SP can be sent along, for example, for the case in which, for some reason a download from one or another of the selected candidate upload terminals T1, T2 was not possible.

In steps 150, 151, the terminal T3 of the third user sends to the terminals T2, T1 of the second and first users, respective request signals using the download ID for control. Then, in steps 152, 153, the requested fragments are transmitted from the terminals T2, T1 to the terminal T3 of the download user. The upload terminals T2, T2 send in steps 154, 155, further utilization data to the system operator SB which in step 156 in performing its regulatory function calculates a compensation for the users of the upload terminals T2, T1. Then in steps 157, 158 corresponding compensation notices are transmitted to the terminals T2, T1 of the respective users.

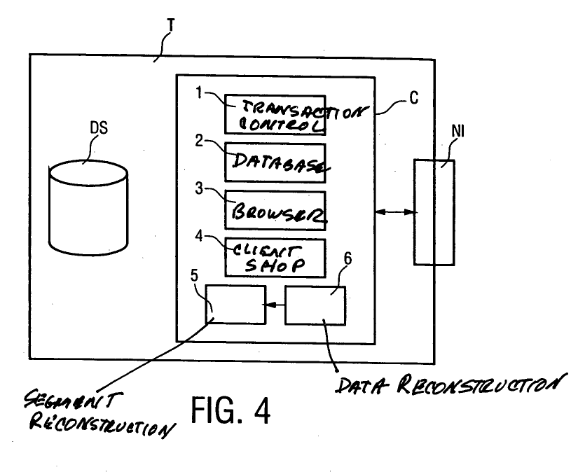

FIG. 3 provides an overview of the architecture of one embodiment of a content transmission system according to the invention.

In this case, it is assumed that the network N which is used, is the internet. To the network N in the usual manner, various terminals T1, T2, T3, Tn of various users of the system are connected. These terminals T1, T2, T3, Tn can be the usual PCs, laptops or the like or other devices which can be suitably connected to a corresponding network N and can serve for downloading and/or processing digital content, like for example Set Top Boxes, MP3 players, mobile radio devices and PDAs which are suitably equipped. What is required in each case is that the terminal T1, T2, T3, Tn contain a data store or memory DS1, DS2, DS3, DSn to which the downloaded data set and/or a data set for an upload can be stored. In addition, to enable the terminal T1, T2, T3, Tn to be used for the method of the invention, appropriate software, hereinafter referred to as “client” should be installed as represented by the functional blocks C1, C2, C3, Cn.

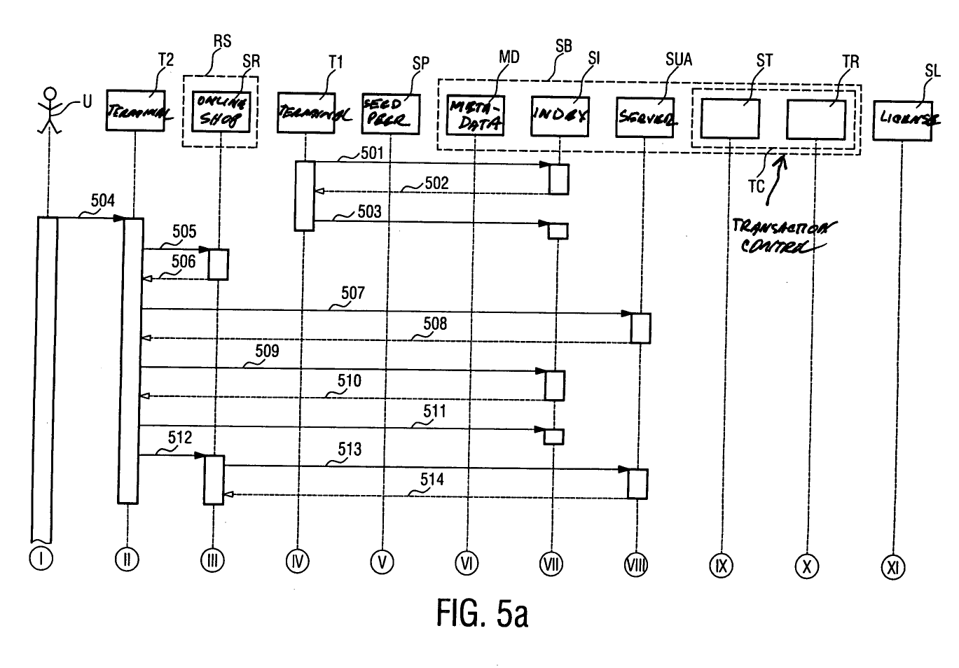

The various components of such a client C have been shown in FIG. 4. In highly schematic form here, T is shown with its data store or memory DS as well as with a network interface NI through which the connection to the internet N can be made. In addition, such a terminal T will be understood to include all further components which such terminals usually contain like, for example, in the case of a normal PC, a motherboard, a processor, a graphics card, a voltage supply, a user interface, etc. All of these components have been omitted so as not to obscure the illustration. They are known to the artisan and need not be explained in greater detail further here.

The client C which is implemented in the form of software on the terminal is comprised of a number of modules.

A first module 1 is a transaction control unit 1 which serves for coordinating the transactions upon a download and/or upload of data sets in accordance with the method of the invention.

Furthermore, the client C has a content database module 2 in which information as to the data sets in readiness for an upload can be stored. Prior to receipt in this content database, as data set is tested with respect to its exchange capability within the content transmission system. To this end, the code of the data set, for example, the hash sum is initially calculated by the client C. A clarification with the content provider or supplier is then carried out as to whether this hash value already exists. In the affirmative, all metadata with respect to the known hash value including information as to the exchange rights associated therewith is downloaded to the local content database module 2 of the client C. For the data sets which are already available within the content transmission system for download upon payment, this test can be omitted since all of the tests have already been carried out for such data sets. As additional security a test is made basically one more time before an upload of fragments to other users of the respective data segments as to whether those fragments can be transmitted, by a comparison with the respective hash sums assigned to the segments. In this manner, the transmission of possible defective data sets can be avoided. Should an error arise, the respective data set is stricken in the content database from the list of datasets available for upload.

A further component of the client C is a browser 3 through which the user can contact the website of the internet shop SR of the content provider RS and through which the user can search the content in the internet shop SR and purchase it. Instead of a browser 3 belonging to the client C, another external browser can be used which has been installed on the terminal T of the user. Possible necessary additional functions can also be installed on the client C to the extent they are permitted by the manufacturer of the external browser and these can also be installed in the external browser. The internal browser of the client C can then be deactivated.

A further component of the client C is, in the illustrated embodiment, an available information unit 4, hereinafter also the “client shop” 4. This client shop 4 enables the user at its terminal T itself to make content available over the internet through the contact provider RS or to make available evaluations or the like at its terminal T for content available for upload. This client shop 4 can be searched by other users with the aid of their browsers 3 directly. A further component of the client C is a segment reconstruction unit 5 in which the requested fragments can be combined again to individual segments and in which the segments can be tested as to whether they are complete and have been correctly received.

The testing is carried out in that following the downloading of a complete segment, the downloaded segment hash sum which is known to the download terminal, is compared. Should an error arise, the following actions are carried out.

Initially, the segments is shifted into a repository for defective segments. There the defective segment is stored along with information as to the upload terminal from where the stored segment was obtained. Then, the segment is downloaded once again from a trusted central server, for example a seed peer SP. The downloaded segment from the seed peer SP is compared with the segment hash sum. If this segment does not match as to the segment hash sum, the error is possibly on the side of the system operator. The result is an interruption of the download and an automatic communication to the central station of the operator. Otherwise, comparison of the correct segment with the corrupt data segment is carried out. On the basis of this comparison, the upload terminal is determined which has supplied the defective data. The defectively transmitting upload terminal is notified by the central of the system operator. The fully reconstructed and tested segment is then transmitted to a data reconstruction unit 6 which carries out a totality check in which a comparison of the data with the total hash sum of the data. Should no further defect be found since it is indeed possible that errors may have already occurred in the testing of the segment, this test is required. Should, in spite of these tests, an error be found, the completely downloaded data set will be erased and an error message sent to the central office of the system operator SB.

Alternatively, a part of the functionality or even the entire functionality can be provided with appropriate hardware in the terminals themselves. The client or at least several of the above-mentioned components of the client can then be installed in the form of hardware in a terminal which, for example, may be especially constructed for the content transmission system of the invention.

On behalf of the system operator SB, within the content transmission system as is shown in FIG. 3, various components are required. One component is the so-called indexing unit SI. The indexing unit SI has a memory DSI in which are registered the terminals T1, T2, T3, Tn, SP1, SP2 which contain the specific content which may be downloaded or which is available for downloading. Apart from this, the indexing unit SI can have a selector unit SU which can choose certain of these terminals T1, T2, T3, Tn, SP1, SP2 as candidate upload terminals as terminals available for uploading when an interrogatory or request as to certain content arrives from a user.

Further components are a transaction control unit TC with an associated memory DTC as well as a metadatabase MD with an associated memory DSM. The functions of these components TC, MD will be elucidated later. A user authentication service SUA is also a part of the system and serves to authenticate the user upon application to this system.

In addition, a licensing server SL is required and which serves to make available the key for unlocking the supplied data set and which assumes the function of a complete Digital Rights Management.

All of these functional units of the system operator SB are as a rule installed on different servers connected to the internet. Basically, however, it is also possible to combine all of the functional units in one server. In addition, the licensing server can be part of this general server to the extent that the system operator SB itself assumes the Digital Rights Management. The content provider RS is, as a rule, connected with its own server to the internet and there operates its content supplier internet shop SR. Basically, however, it is also possible that the system provider SB will make available on its server or server range these features on behalf of the respective content providers although this cannot be noticed by the respective users.

In the example illustrated in FIG. 2, two base storage terminals or seed peers SP1, SP2 can be connected to the internet N and on which content for download to the users is made available. These seed peers SP1 and SP2 can be associated with the system operator SB or the content provider RS. Basically, it is also possible that these seed peer functions can be incorporated in a high power server of the system operator SB. The seed peer can, however, also be operated by an independent third body.

How the individual components operate together in a hierarchical manner will be described in connection with FIG. 5 in greater detail for a download, this figure illustrating the case when a user by means of a terminal T2 downloads certain content from a terminal T1 or another user which has already received this content, as well as from a seed peer.

FIG. 5 has, because of its length been subdivided into partial FIGS. 5a, 5b, 5c. From FIG. 5, it will initially be noted that the first user initially in the system has been established as a possible uploader which makes its content available.

In step 501 from terminal T1 of this upload user a login signal is sent to the indexing unit SI of the system operator SB. The result is the transmission of a singular user ID individual to that terminal and which basically identifies each user in its first registration with the system and provides a respective singular identification for a given user within the overall system. The login in step 502 receives a receipt or acknowledgment from the central indexing unit SI. Then in step 503, the potential upload terminal T1 sends information as to the upload availability of a data set, again using the singular user ID and details of the singular code of the individual data sets, especially the hash values.

Upon the application of a second user U who desires a download of particular content, this application is made initially through the user interface of his terminal T2 in step 504 with a start and login command. The terminal T2 sends next in step 505 a configuration interrogatory to the server or to the internet shop SR installed thereon and maintained by the content provider RS which, then returns in step 506, a configuration reply with which the client C in Terminal T2 is matchingly configured for the subsequent operation. Then in step 507 from the terminal T2 a login interrogatory with a user name and a password is automatically sent and which identifies the user U to the content provider RS. This interrogatory arrives at a user identification service SUA here located at the site and under control of the system operator SB. This user identification service SUA contains an instance which is again under the control of the content provider RS. The result is the generation of a ticket based upon the user name and password which was sent in and which authenticates the user U or for terminal T2 in the following course of the method as to the various functional units. This instance of the user authentication service SUA is so constructed that the system operator SB does not receive and has no interest in the user name and the password of the user U but rather the user name and the password are a common secret of the user U and the content provider RS. The ticket is effective for a complete seating.

Thereafter, the Terminal T2 can optionally in steps 509 through 511, also apply for use as a potential upload terminal at the central indexing device SI. The procedure is identical to the process which has been described above in steps 501 through 503 in which Terminal T1 established its availability as a potential uploader. This means that here as well a login at the central indexing service SI is carried out (step 509) and, after receipt of a login acknowledgment (step 510), an availability signal is sent to the central indexing service SI (step 511).

With the aid of the user authentication service SUA, tickets are received which authenticate the Terminal T2 in step 512 once again with respect to the internet SR (hereinafter referred to also as the reseller shop) of the content provider RS. The ticket is in steps 513, 514 examined by sending it onto the user authentication service SUA and through a corresponding acknowledgment or return message from it.

Then the user in step 515 can search for availability in reseller shop SR and can recognize Terminal T2 for that purpose, whereby in step 516 corresponding signals are transmitted to the reseller shop SR. As to the particular content in which the user may be interested, in steps 517 and 518, metadata is called up from a metadata base MD of the system operator SB. The metadata contains additional information as to the content, like, for example, performers, composer, year of creation, presenter and also license conditions, price, etc. These data have been registered in the database MD and specifically in the memory DSM thereof (see FIG. 3). These data are then, in step 519, transmitted in the form of an offer to the Terminal T2 of the user U and are outputted in step 520 to the user U. The steps 515 through 520 can be carried out by a conventional browser within the internet shop of the content provider, that is the user can optionally initiate various search inquiries, obtain various metadata and offers with respect to a variety of content.

In this example all of the metadata which is available for a particular content has been stored in the central metadata base MD or the memory DSM of the system operator SB. However, it will also be self understood that it is possible that the content provider RS itself will operate such a metadata base in the reseller shop SR. In this case, steps 517, 518 are not required.

In step 521 the user U has determined which particular content is desired and transmits from the Terminal T2 in step 522 a corresponding signal to the reseller shop SR. In the reseller shop, the selected content in step 523 is placed in the users basket. The user U can browse further then within the internet shop of the content provider RS and select further items of content. The steps 515 through 520 can thus be repeated an optional number of times. In addition, it is also possible to erase previously selected items of content from the basket.

When the user U has selected all of the content desired, he can finish the purchase of the contents of the basket in step 524. This takes place at his terminal T2 which transmits in step 525, a purchase signal to the reseller shop SR. The reseller shop SR then in step 526 with the aid of the user or tickets sent by his terminal T2, produces a voucher and a download ID as well as all other data which the user requires to download the content in the system and utilize it. The exact sequence is such that initially in step 526 the reseller shop SR issues a purchase inquiry with the ticket of the user U and sends the information as to the basket of goods to be purchased to a purchase transaction service TS which can be a component of the transaction control device TC of the system operator SB. This purchase transaction service TS initially since the ticket for testing to the user authentication service SUA. Upon receipt of the answer in step 528, the purchase transaction service sends in step 529 an inquiry to the license server SL to create a voucher. After the voucher has been returned in step 530 to the purchase transaction service, the purchase transaction service sends a corresponding purchase reply which contains the voucher as well as the download ID required for the download and the codes of the data set to be downloaded or the individual segments of the data set and optionally further signatures for variation of the transaction at various instances, to the reseller shop SR. This reseller shop sends the reply in step 532 to the terminal T2 of the user U.

The terminal T2 then sends in step 533 automatically based upon the contents of the voucher a request to the license server SL to transmit a license key. In step 534, the license server SL then produces a key corresponding to the license purchased by the user and transmits it in step 535 to the Terminal T2 of the user U.

In step 536, the Terminal T2 then forwards from the central indexing service the list of possible uploaders based upon the particulars of the coding of the data set. The central indexing unit or device SI then maintains in step 537 this list of candidate upload terminals. In doing so, it can use configurable parameters with respect to the selection of uploaders. As a result, a potential uploader has upon login an uploader priority assigned to it. These priorities can be calculated in accordance with the regulations or requirements of the provider RS. The result of this selection is then communicated in step 538 to the Terminal T2, and the candidate upload terminals transmitted based upon these priorities. Based upon these priorities, the terminal T2 then selects the respective candidate upload terminals for the upload. That means that the terminal T2 initially sends to the candidate upload terminal of the highest priority a request signal for the download of the first fragment or fragments. From the terminal with the second highest priority, a second or subsequent fragment is requested until the maximum connection number has been reached. Then the further fragments are requested from the series of previously used upload terminals. If there are several candidate upload terminals with the same priority, the download terminal will select them in accordance with a random selection technique. In the embodiment illustrated in a simplified version in FIG. 5, the terminal T2 of the user U obtains fragments only from the terminal T2 of an upload user and from a central seed peer SP.

In this case, initially in step 539 a download request is given to the upload terminal T1 whereby the code of the desired data set and the download ID is communicated, as were obtained by the terminal T2 at the time of purchase. In step 540, the upload terminal T1 forwards first a verification based upon the download ID and then tests whether the data actually is in readiness for download on the respective terminal T1. In step 541, a reply is then sent to the requesting terminal T2. This terminal then sends in step 542 a concrete fragment request to the upload terminal and gives the code of a segment P0, P1, P2, P3, P4 of the data set D and an offset O_{F} and the length I_{F} of the respective fragment F which is desired.

For an explanation of these values, reference is made again to FIG. 2 and the above description. The offset value O_{F} here gives precisely the starting point of a fragment F within a segment P1 of the data set D. The length I_{F} of the fragment is also given so that through the singular coding of the segment P1, the offset O_{F} and the length I_{F} of the fragment is clearly determined. The lengths of the fragments and their offset values can be automatically supplied to the terminal T2 or the transaction control unit 1 in the client C installed in the terminal T2 (see FIG. 3) depending upon which fragment F is necessary.

In step 543, finally, the requested fragment F is transmitted from upload terminal T1 to the download terminal T2 of the user U. In connection therewith, the upload terminal T1 then sends in step 544 a report to a transaction report receiver TR which is also a component of the transaction control unit TC. In order to insure a reliable and rapid transmission, certain specific time periods can be established in which the data should be transmitted in such a peer to peer transmission. Otherwise, the connection is broken and data from other terminals are requested. For example, should a connection over a certain time interval, for example, in the last five seconds, no longer transmit data and in the time span, in addition, no connection to a terminal has been created and when within a further certain time interval no connection to a seed peer of the system operator or the content provider has been created, a corresponding connection to such a seed peer will be formed to obtain the data set from there. The same result can occur when connections to certain other terminals from down users already exist and over which, however, in a certain time interval, for example more than thirty seconds, data is no longer being transmitted. These connections can then be interrupted and the upload terminal can be marked as poor and the fragment residues can be newly requested.

In addition, also when a multiplicity of further upload terminals are available, respective slow connections can be interrupted, the respective upload terminals marked as slow and a new connection made with a waiting upload terminal in order to accelerate the download.

In steps 545 through 548, a download of fragments from a seed peer SP has been shown. Since here it is certain that the terminal SP contains the desired data set, simultaneously with the download request in step 545, an indication can be given as to which fragments the terminal T2 requires or desires. After the verification in step 546, the requested fragments can be downloaded in the following step 547 to the terminal T2. Finally, also here in step 548 a report is sent to the transaction report receiver TR.

Each request of the download terminal T2 to an upload terminal T1, SP can be in the form of a request block simultaneously requesting a number of fragments. This request signal block is successfully processed by the upload terminals T1, SP. This method reduces the overhead in control data during a download significantly. Since it is possible, utilizing a basket of content that a number of contents or data sets are purchased, in a preferred variant of the method it is also possible that at an upload terminal, for example within a request signal block, fragments of different data sets will be requested in order to optimize the download of the entire basket. It is clear that the terminal T2 can also submit multiple requests one after another to the individual uploaders, for example, upload terminal T1 and the base storage terminal SP so that all fragments of the data will be obtained. In this case, steps 542 and 543 or the steps 545 and 547 will be repeated an optional number of times. In this respect, under certain conditions it may also be sensible to reduce the data overhead by sending the upload reports 544 or 548 only after the termination of the complete upload.

Once the terminal T2 has received all of the fragments of the data set, it transmits in step 549 a download report to the transaction report receiver TR. By comparison of the data obtained from the various terminals, it is possible to determine or control whether the transaction has concluded successively. Apart from this, the compensation for the uploader is calculated as has been described in detail above in connection with FIG. 1.

The accounting however can itself be carried out at a later point in time.

The user can then in step 550 sign off from the reseller shop SP by a corresponding command at his terminal T2. The latter then sends in step 551 a log off signal to the indexing unit Si which then recognizes that the terminal T2 is no longer available for uploads to another user, and in step 552, a further log off signal is sent to the user authentication service SUA which invalidates the ticket.

A problem in such a peer to peer network is that a number of end user terminals may be blocked by firewalls and cannot in a simple manner communicate with the outside in a bidirectional communication, for example, through a TCP connection. Such a connection must always be commenced internally, that is from the firewall secured terminal. To solve this problem preferably in accordance with the method of the invention in a case in which a firewall has been installed in one of the two terminals between which a transmission is to be effected, the connection between the two terminals is made with the aid of a third terminal upon which no firewall is installed.

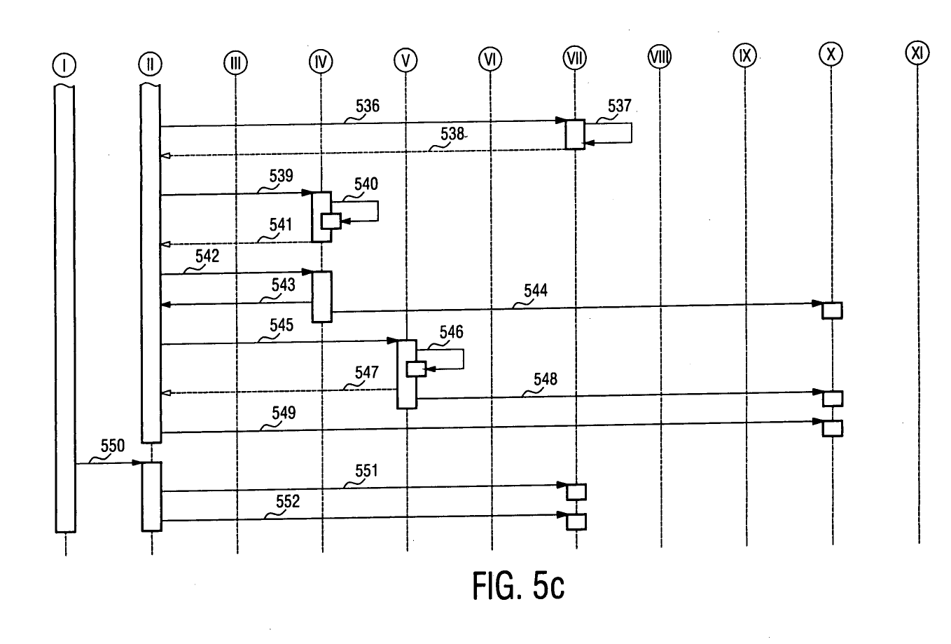

In FIG. 6, a possible course of an application of a firewall-secured terminal TL (hereinafter also “leaf” TL) as a potential upload terminal by the central indexing device SI has been schematically illustrated. When the user U′ initiates the terminal TL through a corresponding command in step 601 for a login, the terminal TL initially in step 602 sends a login signal to the central indexing device SI. This device then sends in step 603 a firewall text signal back simultaneously, in a time loop 604 a determination is made whether a corresponding signal has returned. If this is not the case, it is concluded that the terminal TL is protected by a firewall, that is, is a “leaf”. In step 605, the central indexing unit returns a login answer signal with an address for the upload ready terminal TL and which for the respective terminal TL enables communication through a further terminal TH (below also “hub” TH) which is not protected by a firewall. In step 606, thereafter, a TCP connection is formed between the leaf TL and the hub TH. The hub TH then sends in step 607 a status communication to the central indexing unit SI and an acknowledgment to the leaf TL. The leaf TL next sends in step 609 an availability signal with its user ID and that of the data set available for upload to the central indexing unit SI. The further connection can then follow through the authorized hub TH.

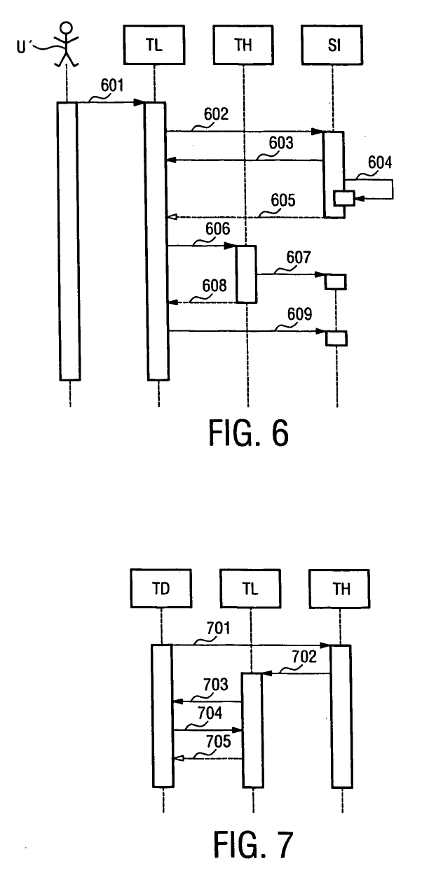

FIG. 7 shows a further example of the case in which a fragment is to be downloaded to a download terminal TD from a firewall protected upload leaf TL.

Since the central indexing unit SI is aware that the upload leaf TF is protected by a firewall and only can communicate via an associated hub TH, with the address data sent to the download terminal TD, the address of this associated hub TH is communicated. The download terminal TD can then send in step 701 initially a push request signal to the hub terminal TH which transmits a corresponding signal over the previously arranged connection in step 702 to the upload leaf TL. This can serve in step 703 to open the communication to the download terminal TD so that in step 704 the download terminal TD in the usual manner can send a request signal for the download of a fragment F to the upload leaf TL and receive in step 705 the desired fragment from it.

In this manner it is possible without additional efforts, not only to exchange data between two terminals which have not been protected by firewalls but also to download data sets to an unprotected terminal from a firewall protected terminal. One must only take care that a leaf always has a hub associated with it. Should a hub be unavailable, by corresponding action at the central indexing unit SI the leaf can in any case acquire a new free hub, whereby the dropout of the hub either through the leaf or through another terminal with which the leaf is in communication, can be determined and a corresponding communicated transmitted to the central indexing unit SI. Similarly, the central indexing unit itself can detect the dropout of a hub for example by having such a hub regularly send status updates to the central indexing device SI and by noting the failure of such a communication at the central indexing unit. In a similar way, the dropout of a leaf can be communicated by the associated hub in the form of a signal to the central indexing unit SI.

It will also be self understood that it is possible to download a data set to a firewall secured terminal from an unsecured terminal since the initiative here is directly from the requesting terminal and in this case can occur once the download terminal protected by the firewall is started. Only a connection between two firewall secured terminals is not possible with this process.

In conclusion it can be noted once again that the aforedescribed embodiments of the invention are especially preferred but exemplary configurations. A number of embodiments of the method of the invention and the device according to the invention are encompassed within the concept of the invention even if they have not been described in detail in the foregoing explanations. Especially various combinations of the described variants are also possible. It will be also understood to the extent that the contrary has not been explicitly set forth in that the indefinite article “a” is not exclusive, that the respective features can also be used in multiples and that the terms “device”, “unit” or “module” do not necessarily mean that the respective components cannot be comprised of other spatially separated cooperating and plural parts.

1. A method of transmitting digital contents of a content provider (RS) to the user of a content transmission system in a computer communications network (N) comprising the steps of:
a) providing a data set (D) which contains specific digital content desired by a download user; and
b) transmitting the data set (D) over the computer communications network (N) at least in part from one terminal (T1, T2) of an upload user to a terminal (T2,T3) of a download user (U) by transmitting the data set from terminals (T1,T2) of different upload users as fragments (F) of the data set (D) to the terminal (T2, T3) of the download user (U).

2. The method according to claim 1 wherein at least a part of the fragments (F) of the data set (D) are transmitted from a base storage terminal (SP, SP1, SP2) to the terminal of the download user (U) to the extent that there is no terminal of an upload user available or too few terminals (T, T1, T2, T3, TN) of upload users are available which are prepared to transmit at least matching parts of the data set (D).

3. The method according to claim 2 wherein request signals are sent from the terminal (T2, T3) of the download user (U) to possible upload terminals (T1, T2, SP) upon which at least parts of the data set (D) are respectively in readiness for a respective upload to request specified fragments (F) of the desired data set to be sent.

4. The method defined in claim 1 wherein the terminal (T2, T3) of the download user sends a request signal block to a possible upload terminal (T1, T2, SP) with which simultaneously a plurality of fragments (F) of the desired data set (D) are requested.

5. The method according to claim 4 wherein from the terminal (T2, T3) of the download user a request is sent for a certain content with a central indexing unit (SI), that from the central indexing unit (SI) a group of candidate upload terminals (T1, T2, SP) is determined on which at least parts of the data set are in readiness for an upload, that from the central indexing unit (SI) to the terminal (T2, T3) of the download user (U) address information relating to the candidate upload terminals (T1, T2, SP) is delivered, and that from the terminal (T2, T3) of the download user (U) request signals are sent to a part of the candidate upload terminal (T1, T2, SP) to request specific fragments (F) of the desired data set (D) to be sent.

6. The method according to claim 5 wherein the central indexing unit (SI) receives an availability signal from a terminal (T) of a user of the content transmission system when on this terminal (T) data is in readiness for an upload to another user of the content transmission system and which contains information as to the data available.

7. The method according to claim 3 wherein a selection of the upload terminals (T1, T2, SP) to which the terminals (T2, T3) of the download user sends a request signal for a transmission of a fragment (F) is effected in dependence upon priority values assigned to the individual upload terminal (T1, T2, SP).

8. The method according to claim 1 wherein the data set (D) is subdivided into a number of distinct claims (PO, P1 P2, P3, P4) and each segment is assigned a singular code.

9. The method defined in claim 1 wherein a request signal is sent from the terminal (T2, T3) of the download user (U) when a fragment (F) is received incompletely or defectively from an upload terminal (T1, T2), to another possible upload terminal (T1, T2, SP) with which a fragment (FR) requested which corresponds to the defective or missing part of the fragment (F) which was sent from the first upload terminal (T2, T2).

10. The method according to claim 9 wherein a request signal from the terminal (T2, T3) of the download user (U) to upload terminal (T1, T2, SP) contains a singular code of the data set (D) and/or the segment (PO, P1, P2, P3, P4) of the data set (D) to which a requested fragment (F, FR) belongs, an offset value (O_{F}, O_{FR}) which represents the position of the fragment (F, F_{R}) within the data set (D) or the segment (PO, P1, P2, P3, P4) of the data set (D) and the length (I_{F}, I_{FR}) of the fragment (F, F_{R}).

11. The method according to claim 1 wherein a user (U) is authenticated initially within an authentication process(102, 122, 142, 507, 508) with respect to an authentication unit (SUA) and that the user (U) after authentication is sent an authentication code, and that the user (U) in the further course of the method is authenticated with respect to other functional units of the content transmission system by the sending of the authentication code.

12. The method according to claim 1 wherein the data set (D) with the desired content in a keyed form is transmitted to the terminal (T1, T2, T3) of the download user (U) and the download user (U) before the transmission of fragments of the data is transmitted a key for unlocking the data set (D).

13. The method according to claim 12 wherein the download user, following a selection of digital content available from a content provider (RS) is sent a data receipt authorization code and a key receipt authorization code and that from the download user (U) the data receipt authorization code is sent to the respective upload terminal (T1, T2, SP) for receipt of the fragments (F) of the desired data set (D) and the key receipt authorization code is sent to the licensing unit (SL) to obtain the key.

14. The method according to claim 1 wherein, following the transmission of fragments (F) of a data set (D) from a terminal (T1, T2) of upload user to a terminal (T2 T3) of a download user (U), user-relevant data is transmitted from terminal (T1 T2) of the upload user and/or from the terminal (T2, T3) of the download user (U) to a transaction control device (TC) and the content provider (RS) and/or an operator (SB) of the content transmission system provides an accounting to the upload users for the availability setting of their terminal for transmitting the data to the terminal (T2, T3) of the download user (U).

15. The method according to claim 1 wherein a content provider (RS) and the operator (SB) of the content transmission system are separate organizational units and each data set (D) with digital contents available from a certain content provider (RS) and/or each segment (P0, P1, P2, P3, P4) of such a data set (D) within the content transmission system has a singular code individual thereto which depends upon the particular content provider (RS) and upon the content of the data set (D) or the segments (P0, P1, P2, P3, P4).

16. The method according to claim 1 wherein a data set (D) with a digital content, which is in readiness on a terminal (T, T1, T2, T3, TN) of a user of the content transmission system for an upload to another user of the content transmission system, initially through in an instance of the content provider (RS) and/or through an instance of an operator (SB) of the content transmission system is tested and the data (D) upon positive proofing is assigned a code.

17. The method according to claim 1 wherein information as to the readiness of a certain user on its terminal (T) to supply an upload to another user of the content transmission system of content can be called up from an available information unit (4) of the terminal (T) of the respective user from a terminal of the other user.

18. A method of downloading a digital content, comprising the steps of:
a) delivering from a content provider (RS) through a computer communication network (N) to a terminal (T2, T3) of a download user of a content transmission system a data set (D) containing certain digital contents desired by the respective download user (U) in a form of fragments (F) of the data set (D) from terminals (T1, T2) of different upload users.

19. The method according to claim 18 wherein the terminal (T2, T3) of the download user receives at least a part of the fragments (F) of the data set (D) from a base storage terminal (SP, SP1, SP2) to the extent that no terminal of an upload user is available or too few terminals (T, T1, T2, T3,TN) of upload users are available on which at least matching parts of the data set (D) are ready for transmission.

20. The method according to claim 18 wherein the terminal (T2, T3) of the download user (U) sends request signals to possible upload terminals (T1, T2, SP) on which at least parts of the data set (D) is respectively in readiness for an upload, to request certain fragments (F) of the desired data (D).

21. The method defined in claim 18 wherein the terminal (T2, T3) of the download user (U) receives fragments (F) of a data set (D) which has a certain digital content desired by the respective download user (U), from an upload terminal (T1, T2) characterized in that the terminal (T2, T3) of the download user (U) sends a request signal block to a possible upload terminal (T1, T2, SP) with which simultaneously a plurality of fragments (F) of the desired data set (D) are requested.

22. The method according to claim 21 wherein the terminals (T2, T3) of the download user (U) sends an inquiry as to specific contents to a central indexing unit (SI), that the terminal (T2, T3) of the download user (U) receives from the central indexing unit (SI), address information as to possible candidate upload terminals (T1, T2, SP) on which at least parts of the data set (D) is respectively in readiness for an upload and that the terminal (T2, T3) of the download user (U) sends request signals at least to a part of the candidate upload terminal to request certain segments of the desired data.

23. The method according to claim 22 wherein a data set is comprised of a number of defined segments (P0, P1, P2, P3, P4) and each segment (P0, P1, P2, P3, P4) is assigned a singular code individual thereto and the request signal from the terminal (T2, T3) of the download user (U) to possible upload terminals (T1, T2, SP) contains the code of the segments (P0, P1, P2, P3, P4) to which the requested fragment (F) belongs.

24. The method defined in claim 18 wherein the terminal (T2, T3) of the download user (U) receives a fragment (F) of a data set (D) which contains a predetermined digital content desired by the respective download user (U) from an upload terminal (T1, T2) characterized in that the terminal (T2, T3) of the download user (U) when a fragment (F) to be transmitted from a first upload terminal (T1, T2) is incompletely or defectively received, sends a request signal to another candidate upload terminal (T1, T2, SP) which requests a fragment (FR) which corresponds to the defective or omitted part of the fragment (F) to be sent from the first upload terminal (T1, T2).

25. The method according to claim 24 wherein a request signal of the terminal (T2, T3) of the download user (U) to an upload terminal (T1, T2, SP) to which the singular code of the data set (D) and/or the segment (P0, P1, P2, P3, P4) of the data set (D) to which a requested fragment (F, FR) within the data set (D) or the segment (P0, P1, P2, P3, P4) of the data set (D), and the length O_{F}, O_{FR}) of the fragment (F, FR).

26. The method according to claim 25 wherein the data set (D) is transmitted with the desired content in keyed from to the terminal (T2, T3) of the download user (U) and the terminal (T2, T3) of the download user, before receiving fragments (F) of the data set (D), receive a key and already received parts of the data (D) are unloaded prior to the ending of a complete data set download.

27. A computer program product which is directly loadable in a memory of programmable terminals, with program code means for carrying out all of the steps of a method according to claim 26 when the program product is applied at the terminal of a content transmission system for transmitting digital content of a content provider (RS) to a terminal (T2, T3) of a download user (U) of a content transmission system in a computer communications network (N) with a transfer initialization device which upon receipt of an inquiry from a download user (U) as to certain contents of the terminal (T2, T3) of the download user (U) permits fragments (F) of the data set (D) with the desired content to be received from different selected candidate upload terminals (T1, T2, SP).

28. A content transmission system for transmitting digital contents of a content provider (RS) to a terminal (T2, T3) of a download user (U) of a content transmission system in a computer communications network (N), comprising a transfer initialization device which upon receipt of an inquiry from a download user (U) as to certain content of the terminal (T2, T3) of the download user (U) as to certain contents of the terminal (T2, T3) of the download user (U) permits fragments (F) of the data set (D) with the desired content to be received from different selected candidate upload terminals (T1, T2, SP).

29. A content transmission system according to claim 28, further comprising a base storage terminal (SP, SP1, SP2) for transmitting a data set (D) with a respective digital content to a terminal (T1, T2) of a download user (U) to the extent that no terminal of an upload user is available or too few terminals of upload users are available on which at least matching parts of the data (D) are in readiness for a transfer.

30. The content transmission system according to claim 28 wherein the transfer initialization device comprises a central indexing unit (SI) with a storage device (DSI) containing information as to which terminals (T, T1, T2, T3, TN) of different users of the content transmission system and/or on which base storage terminals (SP, SP1, SP2) which content is in readiness for transmission to the user over the computer communications network (N), and a selector unit which upon receipt of an interrogatory from a download user (U) as to the specific content form the terminals (T, T1, T2, T3, TN, SP, SP1, SP2) upon which at least part of the data set are respectively in readiness for an upload, determines a group of candidate upload terminals (T1, T2, SP).

31. The content transmission system according to claim 28, further comprising a transaction control unit (TC) which after a transmission of fragments of the data from upload terminals (T1, T2) to the terminal (T2, T3) of the download user, receives use relevant data from the upload terminal and/or the terminal (T2, T3) of the download user to compensate the upload user for the supply or availability setting of the respective upload terminal T1, T2) for transmission of data to the terminal (T2, T3) of the download user (U).

32. A terminal (T, T1, T2, T3, TN) for download of digital contents of a content provider (RS) over a computer communications network (N) with a network interface (NI) to receive fragments (F) of the data set (D) from other terminals (T, T1, T2 T3, TN) connected to the computer communications network and with a transaction control unit (1) which is so configured that the terminal (T, T1, T2, T3, TN) receives fragments (F) of the data (D) from terminals (T, T1, T2, T3, TN) of different upload users.
